(19) United States
(12) Patent Application Publication
(10) Pub. No.: US 2010/0038920 A1
(43) Pub. Date: Feb. 18, 2010

(54) ELECTRIC STRIKE

(76) Inventor: Dong-Shiuan Tsai, Taichung City (TW)

Correspondence Address: Chien-Hui Su, P. O. Box 70-121 Taichung, Taichung City, 40899, TW

(21) Appl. No.: 12/191,311

(22) Filed: Aug. 14, 2008

(51) Int. Cl. E05B 15/02

(52) U.S. Cl. 292/341.16

(57) ABSTRACT

An electric strike includes a base member and a lock assembly mounted in the base member. The lock assembly includes a latch bolt keeper pivotally mounted in the base member by an axle. A control assembly is securely received in the base member. The control assembly includes a solenoid and a stopper driven by the solenoid for selectively engaged to a bottom of the latch bolt keeper to selectively limit a movement of the latch bolt keeper.

### BACKGROUND OF THE INVENTION

1. Field of the Invention

The present invention relates to an electric strike, and more particularly to an electric strike that has a simple structure and a low manufacturing cost.

2. Description of Related Art

A conventional door strike in accordance with the prior art U.S. Pat. No. 6,634,685 to William et al. comprises a base and a latch bolt keeper pivotally mounted on the base. A shaft pin sequentially pivotally extends the base and the latch bolt keeper to prevent the latch bolt keeper from detaching from the base. The base has two opposite sides respectively having a stop lever and a lock lever pivotally mounted thereon. The stop lever and the lock lever are respectively reciprocally wiggled relative to a pivot thereof. The stop lever abuts against the latch bolt keeper and has a free end engaged to the lock lever. An electromagnetic device in mounted on the base and has a casing with a spiral coil disposed in the casing. A plunger centrally extends through casing and the spiral coil and is reciprocally moved relative to the casing. The plunger is moved toward the lock lever for pushing the lock lever and disengaging the stop lever from the lock lever due to an electromagnetic effect when the electromagnetic device is operated. Consequently, the door inward pushes the latch bolt keeper and can be opened when a power is applied to the door. Furthermore, the conventional door strike includes a turning spring sleeved on the shaft pin. The turning spring has two opposite ends respectively abutting against the latch bolt keeper and an outer periphery of the casing of the electromagnetic device for providing a restitution force to the latch bolt keeper and positioning the casing. In addition, the casing has two opposite ends each having a cap attached thereto for closing the casing, wherein one of the two caps is made of magnetic metal and the other is made of non-magnetic metal. The plunger has a shank made of magnetic metal, and a plunger tip longitudinally extending from the shank for pushing the lock lever and made of non-magnetic metal, wherein the shank corresponds to the non-magnetic cap and the plunger tip corresponds to the magnetic cap. Consequently, there is no magnetism remained in the non-magnetic cap due to the operated plunger tip and the plunger can smoothly and quickly moved back into the casing when the electricity is shut-off.

However, the stop lever, the lock lever and the latch bolt keeper of the conventional door strike are connected to one another such that the structure of the convention door strike is complicated because the base needs to define a great space for mounting and operating the stop lever and the lock lever. The stop lever and the lock lever are independent elements such that the structure of the conventional door strike is hard to be simplified. As a result, an interference effect and worn out may occurred among the elements. The caps and the plunger respectively need to be made of magnetic metal or non-magnetic metal such that the manufacturing cost is raised.

The present invention has arisen to mitigate and/or obviate the disadvantages of the conventional door strike.

### SUMMARY OF THE INVENTION

The main objective of the present invention is to provide an improved electric strike that has a simple structure and a low manufacturing cost.

To achieve the objective, the electric strike in accordance with the present invention comprises a base member including a receiving space defined therein and a groove defined in one side of the receiving space. A lock assembly is mounted to the base member and received in the receiving space. The lock assembly includes a latch bolt keeper pivotally mounted to the base member and rotatably received in the receiving space by an axle that extends through the base member and the latch bolt keeper. A resilient leaf is mounted to the axle. The resilient leaf has a first portion abutting against a bottom of the latch bolt keeper for providing a restitution force to the latch bolt keeper and a second portion opposite to the first portion thereof. The latch bolt keeper has a protrusion extending from a bottom thereof. A control assembly is securely received in the received space. The control assembly includes a solenoid with a casing secured on a bottom of the receiving space due to a push force from the second portion of the resilient leaf. A stopper is movably and selectively received in the groove in the base member for selectively engaged to the protrusion of the latch bolt keeper and a resilient member is sandwiched between a bottom of the groove and the stopper for providing a restitution force to the stopper when the stopper is pushed into the groove by the solenoid. A plunger is longitudinally and centrally disposed in the solenoid and selectively extending from the solenoid to push the stopper and compress the resilient member when the solenoid is electrified.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of an electric strike in accordance with the present invention;

FIG. 2 is a perspective view of the electric strike in accordance with the present invention;

FIG. 3 is a perspective view of a lock assembly of the electric strike in accordance with the present invention;

FIG. 4a and FIG. 4b are bottom operational views of the electric strike of the present invention in partial cross-section;

FIG. 5a and FIG. 5b are front cross-sectional operational views of the electric strike of the present invention;

FIG. 6a and FIG. 6b are side cross-sectional operational views the electric strike of the present invention;

FIG. 7 is an exploded perspective view of a second embodiment of the control assembly of the electric strike in accordance with the present invention;

FIG. 8a and FIG. 8b are operational views of the second embodiment of the control assembly in partial cross-section;

FIG. 9a and FIG. 9b are cross-sectional operational views of the second embodiment of the control assembly; and

FIG. 10a and FIG. 10b are side cross-sectional operational views the second embodiment of the control assembly.

### DETAILED DESCRIPTION OF THE INVENTION

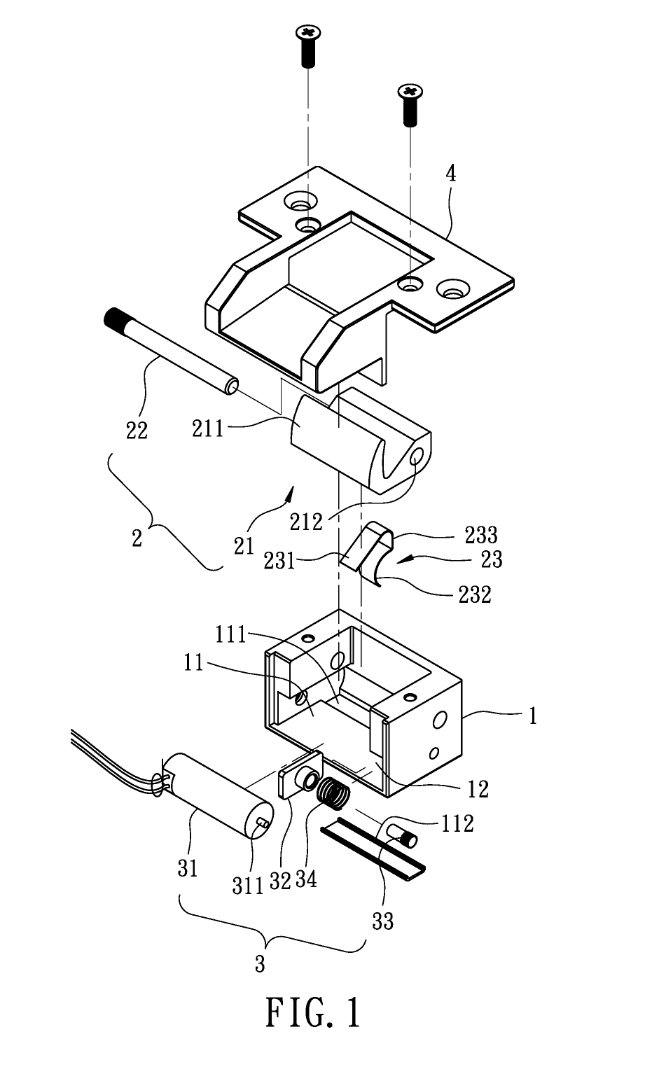

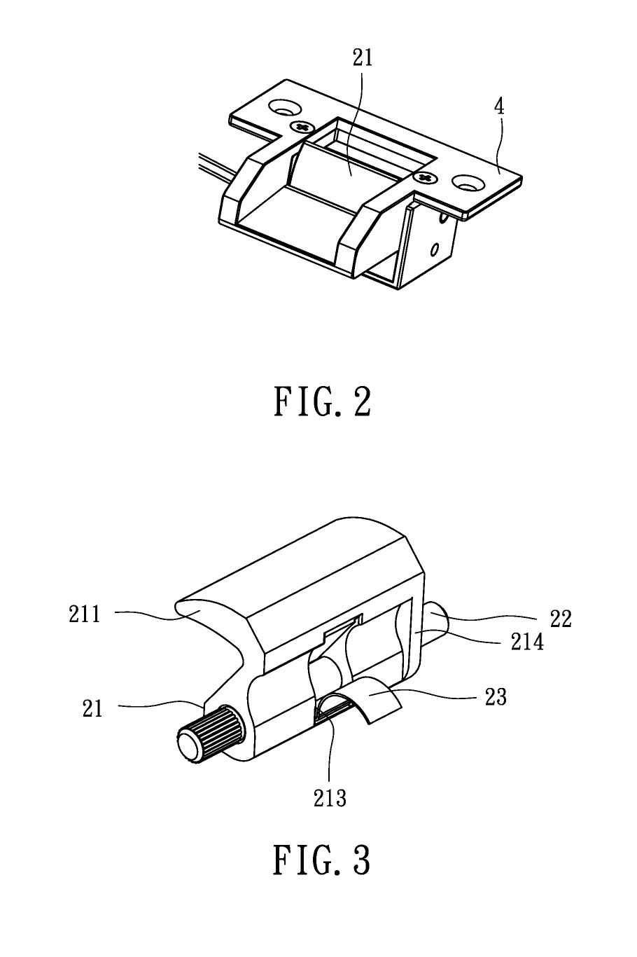

Referring to the drawings and initially to FIGS. 1-3, an electric strike in accordance with the present invention comprises a base member (1), a lock assembly (2) mounted to the base member (1), a control assembly (3) mounted in the base member (1) and a positioning plate (4) mounted on the base member (1), wherein the positioning plate (4) is provided to position the electric strike on a side of a door such that the lock assembly (2) can selectively lock the door due to a connection between the door and the electric strike of the present invention.

The base member (1) includes a receiving space (11) defined therein. The receiving space (11) has two adjacent open sides for sequentially easily assembling the lock assembly (2) and the control assembly (3). The receiving space (11) has two sides each having a groove (12) defined therein and a transverse ditch (111) is defined in a bottom of the receiving space (11) and communicating with the two grooves (12).

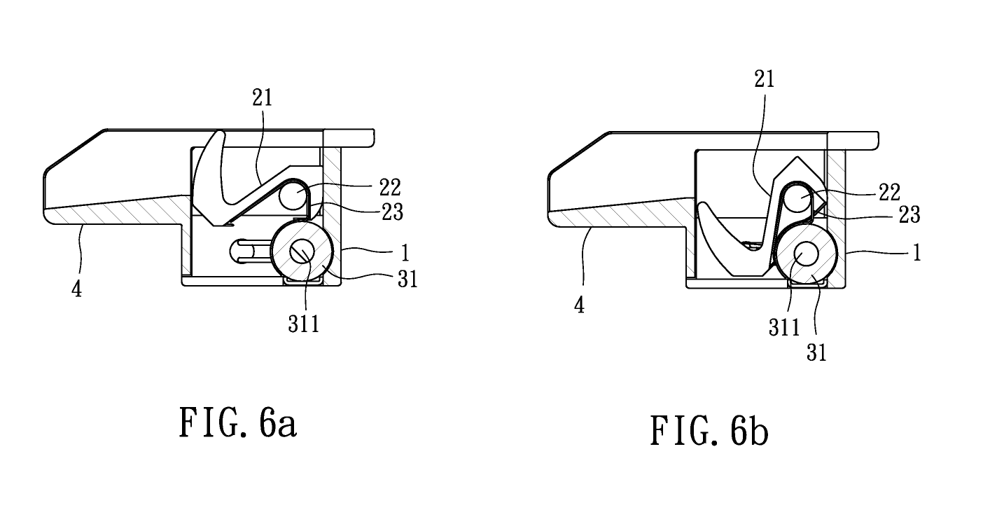

The lock assembly (2) includes latch bolt keeper (21) pivotally mounted to the base member (1) and rotatably received in the receiving space (11) by an axle (22) that extends through the base member (1) and the latch bolt keeper (21). The latch bolt keeper (21) has a through hole (212) laterally defined therein to allow the axle (22) extending therethrough and a transverse hook portion (211) extending from a first side of the latch bolt keeper (21). The hook portion (211) is provided to selectively engage to a door latch for locking the door. The latch bolt keeper (21) has a trough (213) defined in a second side thereof and communicating with the through hole (212). A protrusion (214) perpendicularly extending from a bottom of the latch bolt keeper (21). A resilient leaf (23) is mounted to the axle (22) via the trough (213). Further with reference to FIG. 6a, the resilient leaf (23) has a flat portion (231) abutting against a bottom of the hook portion (211) for providing a restitution force to the latch bolt keeper (21), a curved portion (232) and a connecting portion (233) connecting the flat portion (231) and the curved portion (233), wherein the connecting portion (233) is mounted to the axle (22) and the curved portion (232) abuts against the control assembly (3) to hold the control assembly (3) in place.

The control assembly (3) includes an solenoid (31) having a casing (not numbered) partially received in the ditch (111) and positioned by the curved portion (232) of the resilient leaf (23), wherein the casing of the solenoid (31) is made of magnetic metal. The base member (1) includes a seat (112) crossing the ditch (111) to prevent the solenoid (111) from exposing to the outer periphery of the base member (1). A stopper (32) is movably and selectively received in a corresponding one of the two grooves (12) in the base member (1) for selectively engaged to the protrusion (214) of the latch bolt keeper (21) and a resilient member (34) is sandwiched between a bottom of the corresponding groove (12) and the stopper (32) for providing a restitution force to the stopper (32) when the stopper (32) is outward pushed due to the solenoid (31). A pin (33) centrally extends through the resilient member (34) and telescopically mounted to the stopper (34) for positioning the resilient member (34). The solenoid (31) has a plunger (311) longitudinally and centrally disposed in the solenoid (31) and selectively extending from the solenoid (31) to push the stopper (32) and compress the resilient member (34).

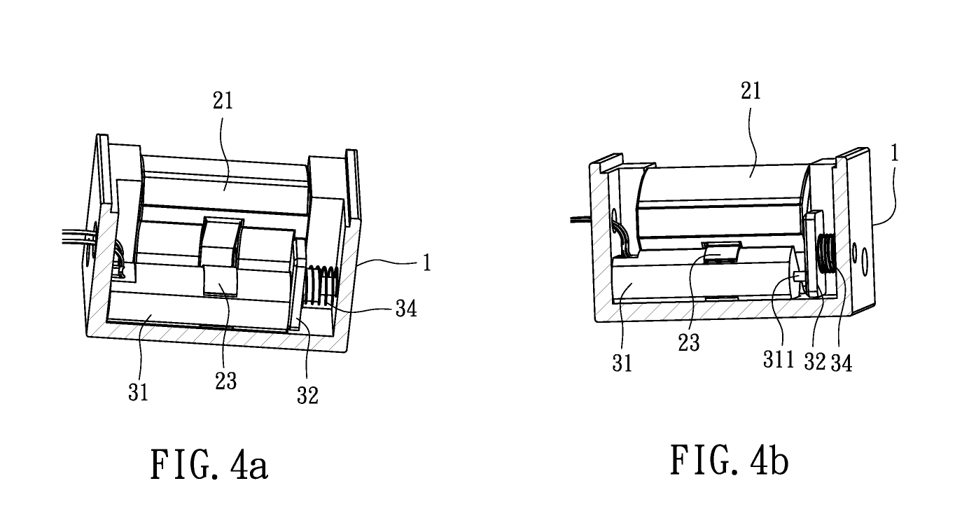

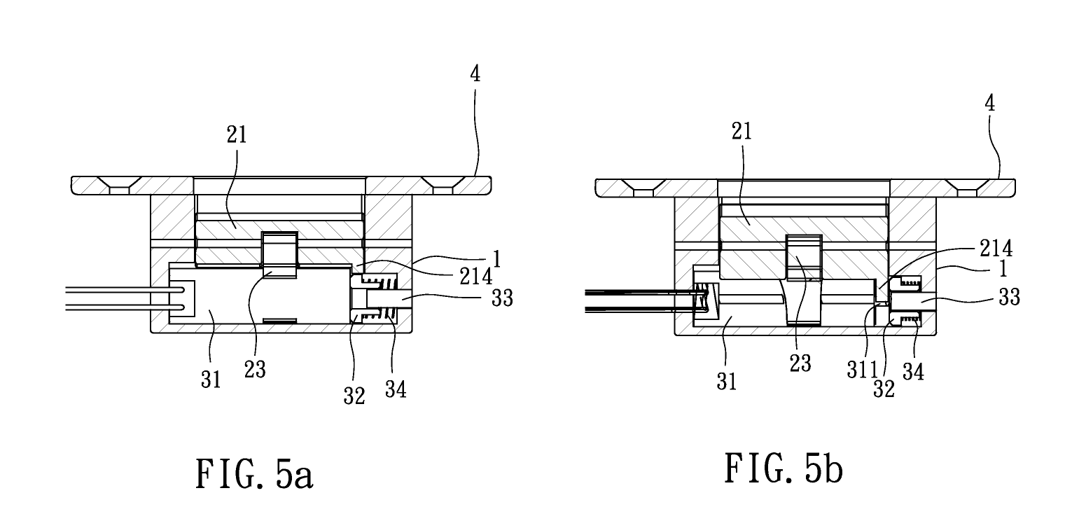

With reference to FIGS. 4a, 5a and 6a, the stopper (32) is moved toward the solenoid (31) and abuts against the protrusion (214) of the latch bolt keeper (21) to limit the movement of the latch bolt keeper (21) due to the restitution force of the resilient member (34) and the resilient leaf (23) when the solenoid (31) is not electrified. With reference to FIGS. 4b, 5b and 6b, the plunger (311) extends to push the stopper (32) into the corresponding groove (12) and compress the resilient member (34), and the stopper (32) is disengaged from the protrusion (214) when the solenoid (31) is electrified. As a result, the latch bolt keeper (21) is in a free condition such that the door can be freely opened or closed. After the door being closed and the power of the solenoid (31) being cut off, the plunger (311) is moved back into the solenoid (31) and the stopper (311) moved toward the solenoid (31) to abut the protrusion (214) again, as shown in FIG. 5a, due to the restitution force of the resilient member (34) such that the latch bolt keeper (21) is positioned and the door is locked.

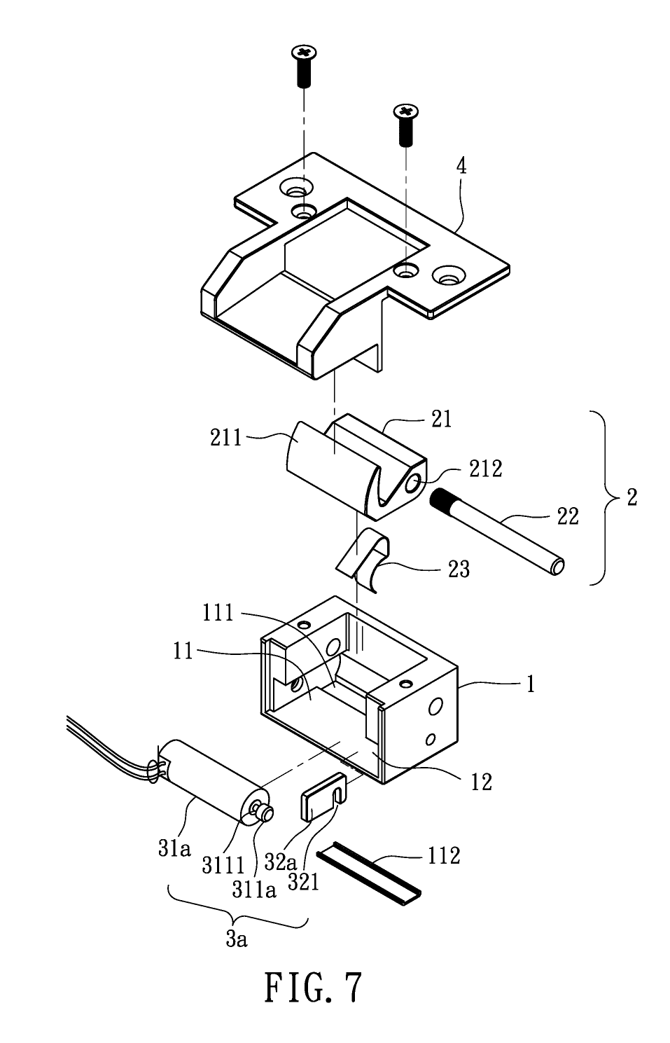

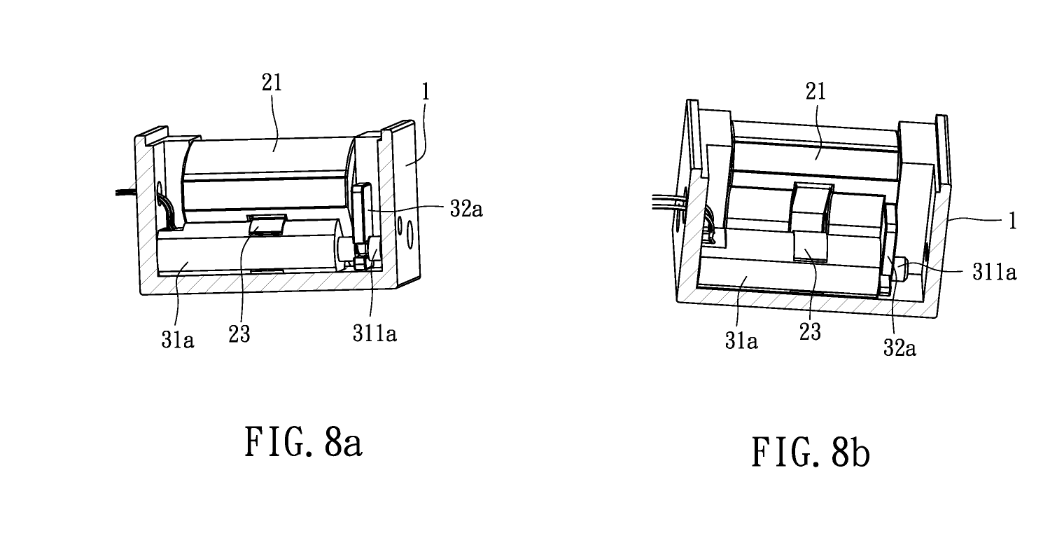

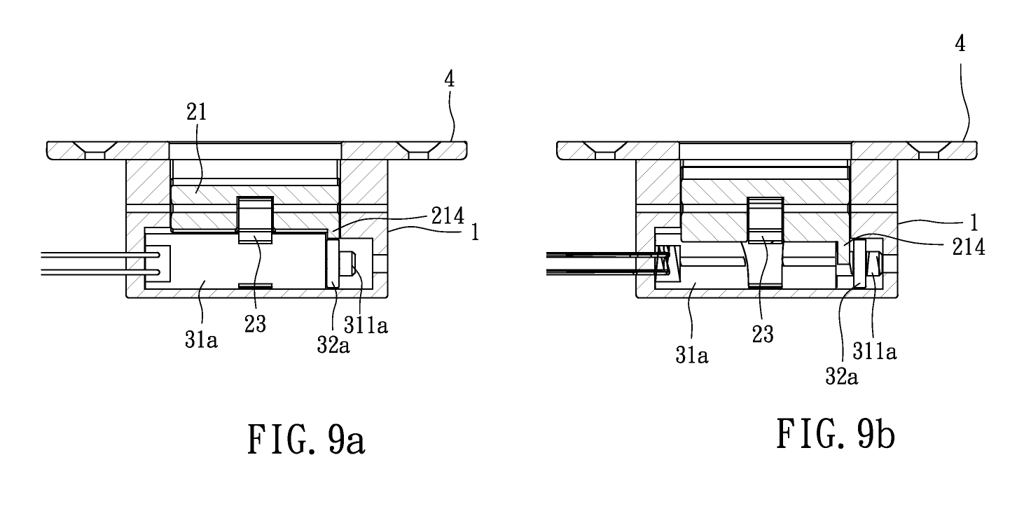

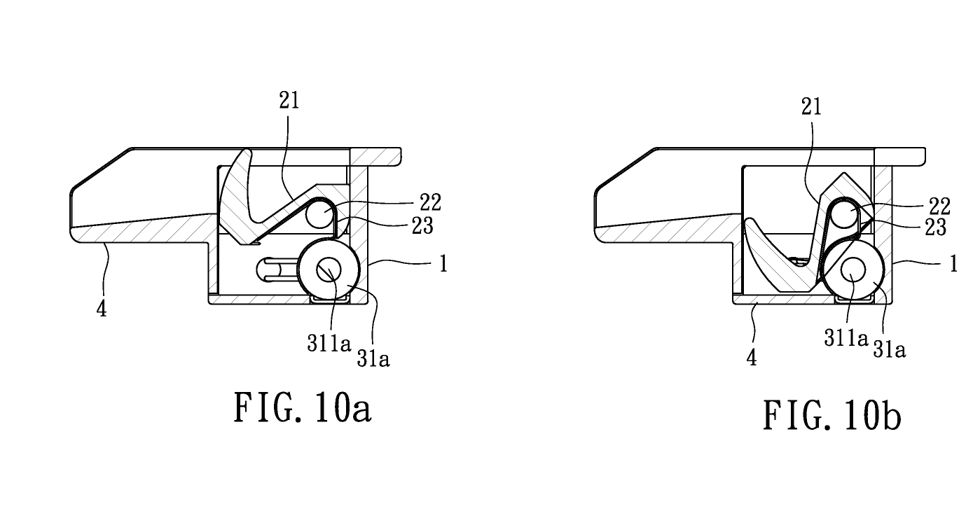

With reference to FIGS. 7 to 10a that show a second embodiment of the control assembly of the electric strike in accordance with the present invention, in this embodiment, most of the elements of the second embodiment is similar to that of the first embodiment. Hereinafter, only the differences between the second embodiment and the first embodiment are described. The plunger (311a) includes a neck (3111) defined near the solenoid (31a) and the stopper (32a) has an indentation (321) defined therein for receiving the neck (3111) such that the stopper (32a) is synchronously moved with the plunger (311a). On the basis of the same operation, the stopper (32a) is moved toward the solenoid (31a) and abuts against the protrusion (214) of the latch bolt keeper (21) to limit the movement of the latch bolt keeper (21) when the solenoid (31a) is electrified, as shown in FIGS. 8a and 9b. The plunger (311a) extends to push the stopper (32a) into the corresponding groove (12) and the stopper (32a) is disengaged from the protrusion (214) when the solenoid (31) is not electrified. As a result, the latch bolt keeper (21) is in a free condition such that the door can be freely opened or closed. After the door being closed and the solenoid (31a) being continually electrified, the plunger (311a) is moved back into the solenoid (31a) and the stopper (311a) moved toward the solenoid (31a) to abut the protrusion (214) again such that the latch bolt keeper (21) is positioned and the door is locked. As described above, the pin (33) and the resilient member (34) of the first embodiment are unnecessary to the second embodiment such that the second embodiment of the electric strike in accordance with the present invention is further advantageously altered.

Although the invention has been explained in relation to its preferred embodiment, it is to be understood that many other possible modifications and variations can be made without departing from the spirit and scope of the invention as hereinafter claimed.

What is claimed is:

1. An electric strike comprising:
a base member including a receiving space defined therein and a groove defined in one side of the receiving space;
a lock assembly mounted to the base member and received in the receiving space, the lock assembly including a latch bolt keeper pivotally mounted to the base member and rotatably received in the receiving space by an axle that extends through the base member and the latch bolt keeper, a resilient leaf mounted to the axle, the resilient leaf having a first portion abutting against a bottom of the latch bolt keeper for providing a restitution force to the latch bolt keeper and a second portion opposite to the first portion thereof, the latch bolt keeper having a protrusion extending from a bottom thereof; and
a control assembly securely received in the received space, the control assembly including an solenoid with a casing secured on a bottom of the receiving space due to a push force from the second portion of the resilient leaf, a stopper movably and selectively received in the groove in the base member for selectively engaged to the protrusion of the latch bolt keeper and a resilient member sandwiched between a bottom of the groove and the stopper for providing a restitution force to the stopper when the stopper is pushed into the groove by the solenoid, a plunger longitudinally and centrally disposed in the solenoid and selectively extending from the solenoid to push the stopper and compress the resilient member when the solenoid is electrified.

2. The electric strike as claimed in claim 1, wherein the latch bolt keeper includes a through hole laterally defined therein to allow the axle extending therethrough, and a trough defined in the latch bolt keeper and communicating with the through hole for easily mounted the resilient leaf to the axle.

3. The electric strike as claimed in claim 1, wherein the first portion of the resilient leaf is flat and the second portion is curved for corresponding to a peripheral of the casing of the solenoid.

4. The electric strike as claimed in claim 1, wherein the control assembly includes a pin centrally extending through the resilient member and telescopically mounted to the stopper for positioning the resilient member.

5. The electric strike as claimed in claim 1 further comprising a positioning plate mounted on the base member and provided to position the base member on the door.

6. The electric strike as claimed in claim 1, wherein the casing of the solenoid is made of magnetic metal.

7. An electric strike comprising:
a base member including a receiving space defined therein and a groove defined in one side of the receiving space;
a lock assembly mounted to the base member and received in the receiving space, the lock assembly including a latch bolt keeper pivotally mounted to the base member and rotatably received in the receiving space by an axle that extends through the base member and the latch bolt keeper, a resilient leaf mounted to the axle, the resilient having a first portion abutting against a bottom of the latch bolt keeper for providing a restitution force to the latch bolt keeper and a second portion opposite to the first portion thereof, the latch bolt keeper having a protrusion extending from a bottom thereof; and
a control assembly securely received in the received space, the control assembly including an solenoid with a casing secured on a bottom of the receiving space due to a push force from the second portion of the resilient leaf, a plunger longitudinally and centrally disposed in the solenoid and selectively extending from the solenoid, a stopper connected to a free end of the plunger, the stopper synchronously moved with the plunger and selectively received in the groove in the base member for selectively engaged to the protrusion of the latch bolt keeper when the solenoid is not electrified.

8. The electric strike as claimed in claim 7, wherein the latch bolt keeper includes a through hole laterally defined therein to allow the axle extending therethrough, and a trough defined in the latch bolt keeper and communicating with the through hole for easily mounted the resilient leaf to the axle.

9. The electric strike as claimed in claim 7, wherein the first portion of the resilient leaf is flat and the second portion is curved for corresponding to a peripheral of the casing of the solenoid.

10. The electric strike as claimed in claim 7, wherein the plunger has a neck defined near a free end thereof and the stopper has an indentation defined to receiving the neck such that the stopper is synchronously moved with the plunger.

11. The electric strike as claimed in claim 7 further comprising a positioning plate mounted on the base member and provided to position the base member on the door.

12. The electric strike as claimed in claim 7, wherein the casing of the solenoid is made of magnetic metal.
